(19) United States
(12) Patent Application Publication
(10) Pub. No.: US 2016/0299754 A1
(43) Pub. Date: Oct. 13, 2016

(54) Method for Updating Application Program, and Terminal

(71) Applicant: ZTE CORPORATION, Shenzhen, Guangdong (CN)

(72) Inventor: Mingye WEI, Shenzhen (CN)

(21) Appl. No.: 15/101,985

(22) PCT Filed: May 20, 2014
(86) PCT No.: PCT/CN2014/077941

§ 371 Date: Jun. 6, 2016

(30) Foreign Application Priority Data
Dec. 6, 2013 (CN) 201310656877.1

(51) Int. Cl. G06F 9/445; H04W 4/02; H04W 4/00

(52) U.S. Cl. CPC G06F 8/65; H04W 4/008; H04W 4/023

(57) ABSTRACT

Provided are a method for updating an application program and a terminal. The method for updating an application program includes that: a distance between a terminal and another terminal with a short-distance wireless communication function is acquired; when the distance is shorter than or equal to a preset data transmission distance, first version information of the terminal and second version information of the other terminal are acquired; when a version type in the first version information of the terminal is the same as a version type in the second version information of the other terminal, a version level in the first version information is compared with a version level in the second version information; and when the version level in the first version information is different from the version level in the second version information, updating is performed according to a high-level version file.

### TECHNICAL FIELD

The present disclosure relates to the technical field of communications, and in particular to a method for updating an application program, and a terminal.

### BACKGROUND

At present, there are various manners for updating a terminal, for example, a terminal is updated by virtue of a specific updating tool after being connected to a Personal Computer (PC) through a data line, or a file to be updated is acquired from a remote server through an Open Mobile Alliance (OMA) protocol in a wireless access manner to perform wireless firmware updating (Firmware Over-The-Air (FOTA)). Updating of an application program mainly includes downloading an update package from a server to a local device and then performing updating. When update packages of a terminal and an application program are relatively large in capacity, a wireless access manner-based updating method requires high traffic consumption, while updating with an updating tool may greatly increase after-sales cost.

At present, a short-distance communication technology is more and more applied to terminals, from primary infrared and Bluetooth communication to present Radio Frequency Identification (RFID) and Near Field Communication (NFC). The short-distance communication technology is also more and more applied to data transmission. However, short-distance communication is not applied sufficient enough to implementation of updating of a terminal and an application program.

### SUMMARY

In order to solve the technical problem of the related art, the embodiments of the present disclosure provide a method for updating an application program, and a terminal.

An embodiment of the present disclosure provides a method for updating an application program, which may be applied to a terminal and may include that:

a distance between the terminal and another terminal with a short-distance wireless communication function is acquired;

when the distance is shorter than or equal to a preset data transmission distance, first version information of the terminal and second version information of the other terminal are acquired;
when a version type in the first version information of the terminal is the same as a version type in the second version information of the other terminal, a version level in the first version information is compared with a version level in the second version information; and
when the version level in the first version information is different from the version level in the second version information, updating is performed according to a high-level version file.

Another embodiment of the present disclosure provides a terminal, which may include: a first acquisition component, a second acquisition component, a comparison component and an updating component, wherein
the first acquisition component may be configured to acquire a distance between the terminal and another terminal with a short-distance wireless communication function is acquired;
the second acquisition component may be configured to, when the distance is shorter than or equal to a preset data transmission distance, acquire first version information of the terminal and second version information of the other terminal;
the comparison component may be configured to, when a version type in the first version information of the terminal is the same as a version type in the second version information of the other terminal, compare a version level in the first version information with a version level in the second version information; and
the updating component may be configured to, when the version level in the first version information is different from the version level in the second version information, perform updating according to a high-level version file.

The technical solutions of the embodiments of the present disclosure at least have beneficial effects as follows.

In the method for updating an application program of the embodiment of the present disclosure, a short-distance communication technology is adopted to share terminal versions of the same type or software application versions of the same type and perform updating, so that traffic of a user is saved. In addition, a server only plays a role in positioning the terminals, so that an interaction process between the server and the terminals is simplified, and pressure of the server is reduced.

### BRIEF DESCRIPTION OF THE DRAWINGS

FIG. 1 is a flowchart of basic steps of a method for updating an application program according to an embodiment of the present disclosure;

FIG. 2 is a basic structure diagram of a terminal according to an embodiment of the present disclosure;

FIG. 3 is a flowchart of updating under the condition that a server has version information of the terminals according to an embodiment of the present disclosure; and

FIG. 4 is a flowchart of updating under the condition that a server does not have version information of the terminals according to an embodiment of the present disclosure.

### DETAILED DESCRIPTION OF THE EMBODIMENTS

In order to make the technical solution to be solved, technical solutions and advantages of the present disclosure clearer, detailed descriptions will be given below with reference to the drawings and specific embodiments.

For the problems of higher traffic consumption and higher after-sales cost of updating methods in related art, the embodiments of the present disclosure provide a method for updating an application program, and a terminal. A short-distance communication technology is adopted to share terminal versions of the same type or software application versions of the same type and perform updating, so that traffic of a user is saved. In addition, a server only plays a role in positioning the terminals, so that an interaction process between the server and the terminals is simplified, and pressure of the server is reduced.

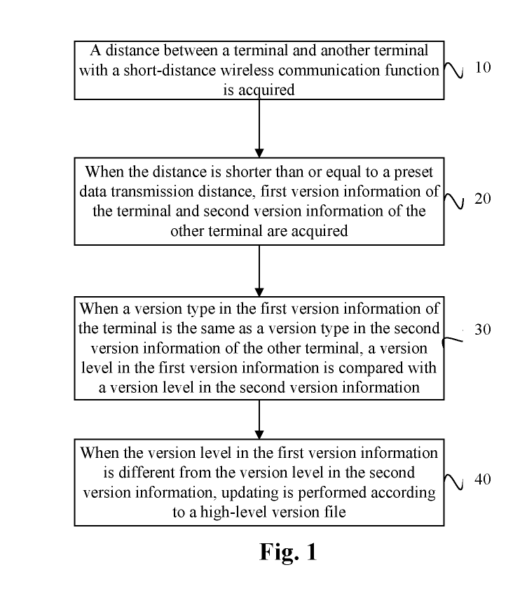

As shown in FIG. 1, an embodiment of the present disclosure provides a method for updating an application program, which is applied to a terminal and may include:

Step 10: a distance between the terminal and another terminal with a short-distance wireless communication function is acquired;

Step 20: when the distance is shorter than or equal to a preset data transmission distance, first version information of the terminal and second version information of the other terminal are acquired;

Step 30: when a version type in the first version information of the terminal is the same as a version type in the second version information of the other terminal, a version level in the first version information is compared with a version level in the second version information; and

Step 40: when the version level in the first version information is different from the version level in the second version information, updating is performed according to a high-level version file.

In the embodiment of the present disclosure, the distance between the terminal and the other terminal should be shorter than or equal to the preset data transmission distance in order to adopt the short-distance wireless communication function to implement version sharing. The preset data transmission distance may be determined according to a selected wireless transmission method, for example, the preset data transmission distance may be set to be 10 meters when the selected wireless transmission method is Bluetooth transmission, and the preset data transmission distance may be set to be 10 centimeters when the selected wireless transmission method is NFC transmission. The preset data transmission distance may be determined by further considering signal strength, an intermediate obstacle and the like comprehensively, and is not limited to a fixed value. NFC, also called short-distance wireless communication, is a short-distance high-frequency wireless communication technology, and allows non-contact point-to-point data transmission (within 10 centimeters) for data exchange between electronic equipment. Such a technology is evolved from non-contact RFID, is downwards compatible with RFID, was primarily successfully developed by Sony and Philips respectively, and is mainly configured to provide Machine to Machine (M2M) communication in handheld equipment such as a mobile phone. NFC has natural security, so that an NFC technology is considered to have broad application prospect in the fields of payment with mobile phones and the like. In addition, NFC is also likened to “secure conversation” between machines by the SharKing IOT Circle because its security is higher than that of other wireless communication technologies.

Preferably, in an exemplary embodiment of the present disclosure, updating may be performed by virtue of the high-level version file only when the terminal and the other terminal have terminal versions of the same type or software application versions of the same type. If the version types of the first version information of the terminal and the second version information of the other terminal are different, the high-level version file cannot be acquired, and updating cannot be implemented. Then, Step 20 is that the first version information of the terminal and the second version information of the other terminal are acquired; and Step 30 in which the version level in the first version information is compared with the version level in the second version information is executed on the premise that the version types in the version information of the terminal and the other terminal are the same. If the version levels are the same, no operation is executed; while if the levels are different, the high-level version file is shared, and the terminal of a low-level version is updated according to the high-level version file. By virtue of the solution, high traffic consumption caused by updating with a wireless access manner is avoided, and in addition, updating is implemented without any updating tool to greatly reduce after-sales cost. According to the embodiment of the present disclosure, the short-distance communication technology is adopted to share terminal versions of the same type or software application versions of the same type and perform updating, so that traffic of a user is saved. In addition, a server only plays a role in positioning the terminals, so that an interaction process between the server and the terminals is simplified, and pressure of the server is reduced.

Preferably, the first version information in an exemplary embodiment of the present disclosure is system version information of the terminal or application program version information of the terminal; and the second version information is system version information of the other terminal or application program version information of the other terminal. It is important to note that the first and second version information is better to be version information of the same type when the version types of the first version information and the second version information are compared. For example, when the first version information is the system version information of the terminal, the second version information with which the second version information is compared is better to be the system version information of the other terminal too.

In an exemplary embodiment of the present disclosure, Step 10 may include:

Step 101: positions of the terminal and the other terminal with the short-distance wireless communication function are acquired from a server; and

Step 102: the distance between the terminal and the other terminal with the short-distance wireless communication function is calculated according to the positions.

In an exemplary embodiment of the present disclosure, the server may acquire the positions of the terminals in real time. Since the terminal and the other terminal may be under movement, their positions may constantly change, and the server may acquire the real-time positions of the terminals by virtue of a method such as Global Positioning System (GPS) positioning and calculate the distance between the two terminals according to the specific positions (such as latitudes and longitudes) of the two terminals. When the distance is within a data transmission range, file sharing can be implemented by virtue of the short-distance wireless communication function, so that a file acquisition step is simplified, and traffic is greatly saved.

In an exemplary embodiment of the present disclosure, Step 20 may include:

Step 201: the first version information of the terminal and the second version information of the other terminal are acquired from the server.

In an exemplary embodiment of the present disclosure, if the server has the first version information of the terminal and the second version information of the other terminal, Step 201 is executed, and the first version information of the terminal and the second version information of the other terminal are acquired from the server.

In an exemplary embodiment of the present disclosure, Step 20 may include:

Step 202: an authentication message is sent to the other terminal; and

Step 203: the second version information, fed back by the other terminal receiving the authentication message, of the other terminal is received.

In an exemplary embodiment of the present disclosure, the authentication message may be sent by the terminal and may alternatively be sent by the server when being sent to the other terminal in Step 202. If it is the server sending the authentication message, the authentication message may be sent to any one of the terminal and the other terminal, and the same effects can be achieved. For example, if the server sends the authentication message to the terminal, the terminal receiving the authentication message sends the first version information to the other terminal through the authentication message; and if the server sends the authentication message to the other terminal, the other terminal receiving the authentication message sends the second version information to the terminal through the authentication message.

In an exemplary embodiment of the present disclosure, Step 40 may include:

Step 401: when the version level in the first version information of the terminal is lower than the version level in the second version information of the other terminal, an updating request is sent to the other terminal;

Step 402: a version updating file fed back by the other terminal is received; and

Step 403: updating is performed according to the version updating file.

In an exemplary embodiment of the present disclosure, when the version level of the terminal is lower, the updating request is sent to the other terminal, the other terminal receiving the updating request sends its own high-level version file to the terminal, and the terminal is updated after receiving the high-level version file. After updating is implemented, if the server originally has the version information of the terminal, the updated version information may be fed back to the server; and if the server originally does not have the version information, no information is required to be fed back to the server. Since the short-distance wireless communication function is adopted for file sharing, traffic of the terminals is saved, the interaction process between the server and the terminals is simplified at the same time, and pressure of the server is reduced.

In an exemplary embodiment of the present disclosure, Step 402 may include:

Step 4021: a data sharing function is enabled, and a version response fed back by the other terminal is received, wherein the version response at least includes: the second version information of the other terminal and an acquisition manner for the version updating file of the other terminal; and

Step 4022: the version updating file of the other terminal is acquired according to the version response.

In an exemplary embodiment of the present disclosure, considering a security problem of information transmission, namely for correctly sending information to the terminal sending the request, Step 4021 is executed, that is, the version response of the other terminal is received after the data sharing function is enabled, version response at least including the second version information of the other terminal and the acquisition manner for the version updating file of the other terminal. However, the version response does not include the version updating file, the terminal continues acquiring the version updating file of the other terminal according to the version response. In an exemplary embodiment of the present disclosure, Step 4022 may include:

Step 40221: a version request is sent to the other terminal according to the version response; and

Step 40222: the version updating file, corresponding to the version request, of the other terminal is received. That is, identity confirmation is further performed on the terminal sending the updating request to improve version file sending accuracy, ensure information transmission security and avoid mistaken information transmission.

In an exemplary embodiment of the present disclosure, Step 40 may include:

Step 404: when the version level in the first version information of the terminal is higher than the version level in the second version information of the other terminal, an updating request from the other terminal is received; and

Step 405: a version updating file is sent to the other terminal to enable the other terminal to perform updating according to the version updating file.

In the exemplary embodiment of the present disclosure, when the version level of the terminal is higher, the other terminal sends the updating request to the terminal, the terminal receiving the updating request sends its own high-level version file to the other terminal, and the other terminal is updated after receiving the high-level version file. After updating is implemented, if the server originally has the version information of the other terminal, the updated version information may be fed back to the server; and if the server originally does not have the version information, no information is required to be fed back to the server. Since the short-distance wireless communication function is adopted for file sharing, traffic of the terminals is saved, the interaction process between the server and the terminals is simplified at the same time, and pressure of the server is reduced.

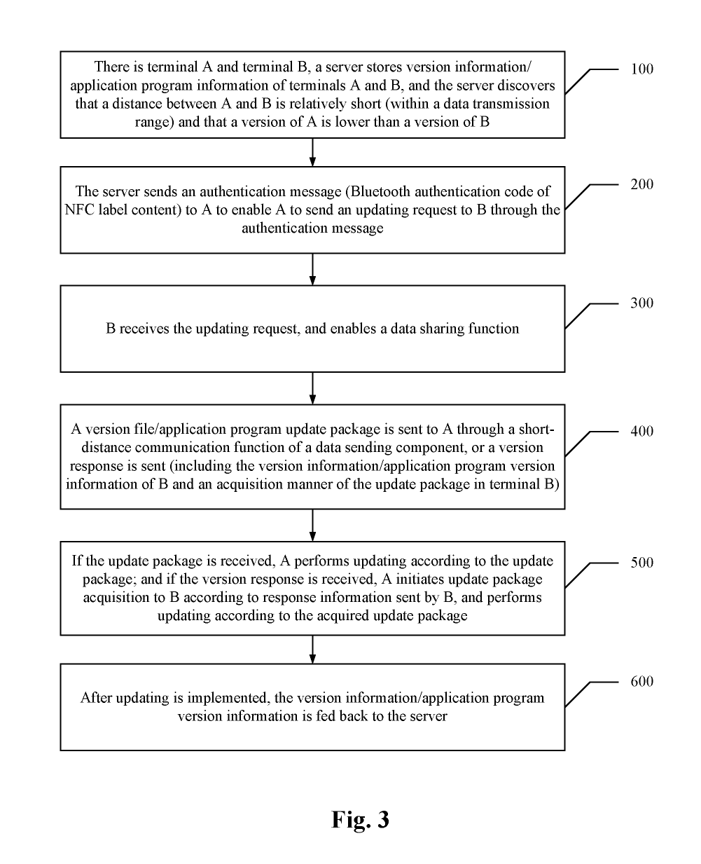

An updating flow under the condition that the server has the version information of the terminal and the other terminal is described with an example, as shown in FIG. 3:

it is supposed that the terminal is terminal A and the other terminal with the short-distance wireless communication function is terminal B.

Step 100: the server has system version information/application program information of terminals A and B, the system version information/application program information of terminals A and B is acquired from the server when the server detects that a distance between terminals A and B is relatively short (within a data transmission range), an authentication message is prepared to be sent when version types of terminals A and B are the same/application programs are the same, and no operation is performed when the version types of terminals A and B or the application programs are different;

Step 200: if a terminal version or application program version of A is lower than that of B, the server sends the authentication message (Bluetooth authentication code or NFC label content) to A to enable A to send an updating request to B through the authentication message;

Step 300: when receiving the updating request, terminal B enables a data sharing function through a data sharing component, and stores a version update package and an application program update package in a memory;

Step 400: a data sending component of terminal B acquires information to be sent from the data sharing component and sends a version updating file/application program version file to terminal A, or for higher security, terminal B sends a version response to terminal A through version identification information of terminal A, including the system version information/application program version information of terminal B and an acquisition manner for a system version/application program version of terminal B;

Step 500: terminal A judges the information received from terminal B, performs updating according to the version file if the version file is received, and initiates a version request to terminal B through standard information if the version identification information is received, and terminal B sends a version to terminal A through the data sending component (Bluetooth, NFC, Wireless Fidelity (WiFi) direct or the like) according to the corresponding version request, and then implements updating; and

Step 600: the system version information/application program version information of terminal A is fed back to the server.

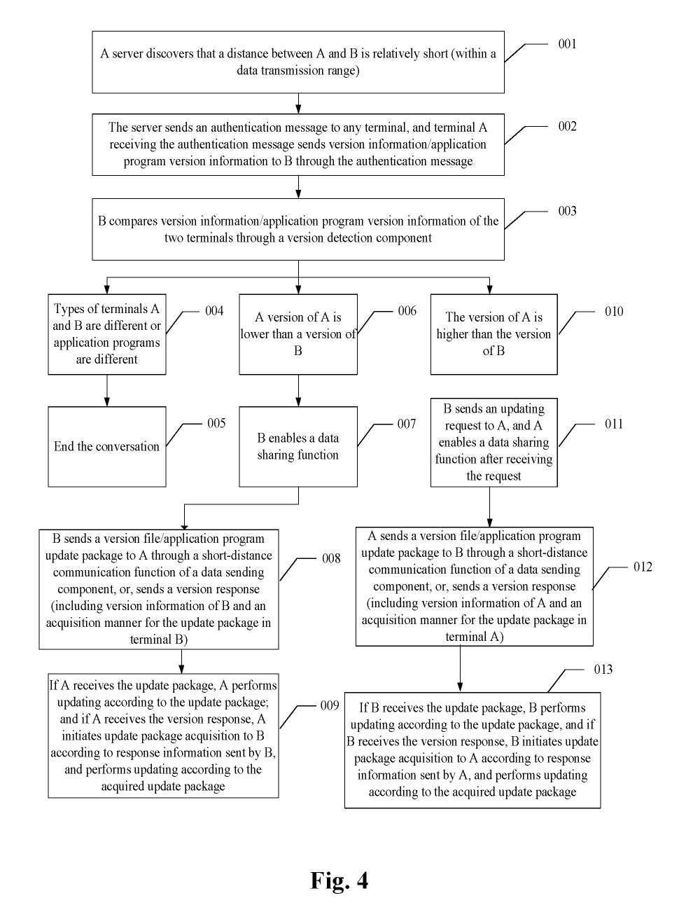

An updating flow under the condition that the server does not have the version information and/or application program information of the terminal and the other terminal is described with an example, as shown in FIG. 4:

it is supposed that the terminal is terminal A and the other terminal with the short-distance wireless communication function is terminal B.

Step 001: the server does not have system version information/application program information of terminals A and B, and the server detects that a distance between terminals A and B is relatively short and within a data transmission range;

Step 002: the server sends an authentication message to any terminal, and the terminal, for example, terminal A in the present exemplary embodiment, receiving the authentication message sends the version information/application program information to B through the authentication message;

Step 003: terminal B compares the terminal version and application program version information of terminal A and terminal B after receiving the system version information/application program version information;

Step 004: it is determined that version types of terminal A and terminal B are different, or A and B do not have the same application;

Step 005: this conversation is ended;

Step 006: a system version/application program version level of terminal A is lower than a system version/application program version of terminal B;

Step 007: terminal B enables a data sharing function through a data sharing component, and stores a version update package or an application program update package in a memory;

Step 008: a data sending component of terminal B acquires information to be sent from the data sharing component and sends a system version updating file/application program version update package to terminal A, or for higher security, terminal B sends a version response to terminal A through version identification information of terminal A, including the version information/application program version information of terminal B and an acquisition manner for the system version/application program update package of terminal B;

Step 009: terminal A judges the information received from terminal B, if the system version updating file/application program update package is received, terminal A performs updating according to the system version updating file/application program update package; and if the version identification information is received, terminal A initiates a version request to terminal B through standard information, and terminal B sends a version to terminal A through the data sending component (Bluetooth, NFC, WiFi direct or the like) according to the corresponding version request, and then terminal A implements updating;

Step 010: the version/application program version level of terminal A is higher than that of terminal B;

Step 011: B sends an updating request to A, and A enables a data sharing function through a data sharing component after receiving the request, and stores a system version update package/application program update package in a memory;

Step 012: a data sending component of terminal A acquires information to be sent from the data sharing component and sends a system version updating file/application program version update package to terminal B, or for higher security, terminal A sends a version response to terminal B through version identification information of terminal B, including system version/application program update package information of terminal A and an acquisition manner for the system version/application program update package of terminal A; and

Step 013: terminal B judges the information received from terminal A, if the system version updating file/application program update package is received, terminal B performs updating according to the system version updating file/application program update package; and if the version identification information is received, terminal B initiates a version request to terminal A through standard information, and terminal A sends a version to terminal B through the data sending component (Bluetooth, NFC, WiFi direct or the like) according to the corresponding version request, and then terminal B implements updating.

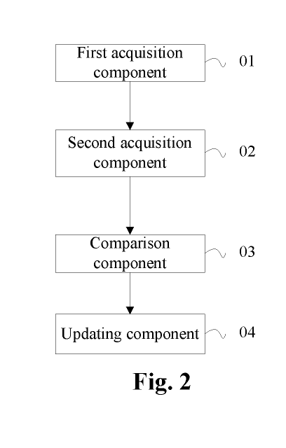

As shown in FIG. 2, in order to better implement the abovementioned method, the embodiment of the present disclosure further provides a terminal, which may include:

a first acquisition component 01, which may be a positioning chip or receiver and configured to acquire a distance between the terminal and another terminal with a short-distance wireless communication function;

a second acquisition component 02, which may be a communication interface and configured to, when the distance is shorter than or equal to a preset data transmission distance, acquire first version information of the terminal and second version information of the other terminal;

a comparison component 03, which may be a processor and configured to, when a version type in the first version information of the terminal is the same as a version type in the second version information of the other terminal, compare a version level in the first version information with a version level in the second version information; and

an updating component 04, which may be a processor and configured to, when the version level in the first version information is different from the version level in the second version information, perform updating according to a high-level version file.

In an exemplary embodiment, the first version information is system version information of the terminal or application program version information of the terminal; and the second version information is system version information of the other terminal or application program version information of the other terminal.

In an exemplary embodiment, the first acquisition component 01 may include:

a first determination element, configured to acquire positions of the terminal and the other terminal with the short-distance wireless communication function from a server; and

a calculation element, configured to calculate the distance between the terminal and the other terminal with the short-distance wireless communication function according to the positions.

In an exemplary embodiment, the second acquisition component 02 may include:

a second determination element, configured to acquire the first version information of the terminal and the second version information of the other terminal from the server.

In an exemplary embodiment, the second acquisition component may include:

a first sending element, configured to send an authentication message to the other terminal; and

a first receiving element, configured to receive the second version information, fed back by the other terminal receiving the authentication message, of the other terminal.

In an exemplary embodiment, the updating component 04 may include:

a second sending element, configured to, when the version level in the first version information of the terminal is lower than the version level in the second version information of the other terminal, send an updating request to the other terminal;

a second receiving element, configured to receive a version updating file fed back by the other terminal; and

a first updating element, configured to perform updating according to the version updating file.

In an exemplary embodiment, the second receiving element may include:

a receiving sub-element, configured to enable a data sharing function and receive a version response fed back by the other terminal, wherein the version response at least includes: the second version information of the other terminal and an acquisition manner for the version updating file of the other terminal; and

an acquisition element, configured to acquire the version updating file of the other terminal according to the version response.

In an exemplary embodiment, the acquisition element may include:

a third sending element, configured to send a version request to the other terminal according to the version response; and

a third receiving element, configured to receive the version updating file, corresponding to the version request, of the other terminal.

In an exemplary embodiment, the updating component 04 may include:

a fourth receiving element, configured to, when the version level in the first version information of the terminal is higher than the version level in the second version information of the other terminal, receive an updating request from the other terminal; and

a second updating element, configured to send a version updating file to the other terminal to enable the other terminal to perform updating according to the version updating file.

In the method for updating an application program of the embodiments of the present disclosure, a short-distance communication technology is adopted to share terminal versions of the same type or software application versions of the same type and perform updating, so that traffic of a user is saved. In addition, a server only plays a role in positioning the terminals, so that an interaction process between the server and the terminals is simplified, and pressure of the server is reduced. It is important to note that the terminal in the embodiment of the present disclosure is a terminal capable of implementing the abovementioned method for updating an application program, then all the embodiments and beneficial effects of the method are applicable to the terminal and the same technical effects may be achieved.

The above is only the exemplary implementation mode of the present disclosure, it should be pointed out that those skilled in the art may also make a plurality of improvements and embellishments without departing from the principle of the present disclosure, and these improvements and embellishments shall fall within the scope of protection defined by the claims of the present disclosure.

What is claimed is:

1. A method for updating an application program, applied to a terminal and comprising:
acquiring a distance between the terminal and another terminal with a short-distance wireless communication function;
when the distance is shorter than or equal to a preset data transmission distance, acquiring first version information of the terminal and second version information of the other terminal;
when a version type in the first version information of the terminal is the same as a version type in the second version information of the other terminal, comparing a version level in the first version information with a version level in the second version information; and
when the version level in the first version information is different from the version level in the second version information, performing updating according to a high-level version file.

2. The method for updating an application program as claimed in claim 1, wherein the first version information is system version information of the terminal or application program version information of the terminal; and the second version information is system version information of the other terminal or application program version information of the other terminal.

3. The method for updating an application program as claimed in claim 1, wherein acquiring the distance between the terminal and the other terminal with the short-distance wireless communication function comprises:
acquiring positions of the terminal and the other terminal with the short-distance wireless communication function from a server; and
calculating the distance between the terminal and the other terminal with the short-distance wireless communication function according to the positions.

4. The method for updating an application program as claimed in claim 1, wherein acquiring the first version information of the terminal and the second version information of the other terminal comprises:
acquiring the first version information of the terminal and the second version information of the other terminal from the server.

5. The method for updating an application program as claimed in claim 1, wherein acquiring the first version information of the terminal and the second version information of the other terminal comprises:
sending an authentication message to the other terminal; and
receiving the second version information, fed back by the other terminal receiving the authentication message, of the other terminal.

6. The method for updating an application program as claimed in claim 1, wherein when the version level in the first version information is different from the version level in the second version information, performing updating according to the high-level version file comprises:
when the version level in the first version information of the terminal is lower than the version level in the second version information of the other terminal, sending an updating request to the other terminal;
receiving a version updating file fed back by the other terminal; and
performing updating according to the version updating file.

7. The method for updating an application program as claimed in claim 6, wherein receiving the version updating file fed back by the other terminal comprises:
enabling a data sharing function and receiving a version response fed back by the other terminal, wherein the version response at least comprises: the second version information of the other terminal and an acquisition manner for the version updating file of the other terminal; and
acquiring the version updating file of the other terminal according to the version response.

8. The method for updating an application program as claimed in claim 7, wherein acquiring the version updating file of the other terminal according to the version response comprises:
sending a version request to the other terminal according to the version response; and
receiving the version updating file, corresponding to the version request, of the other terminal.

9. The method for updating an application program as claimed in claim 1, wherein when the version level in the first version information is different from the version level in the second version information, performing updating according to the high-level version file comprises:
when the version level in the first version information of the terminal is higher than the version level in the second version information of the other terminal, receiving an updating request from the other terminal; and
sending a version updating file to the other terminal to enable the other terminal to perform updating according to the version updating file.

10. A terminal, comprising: a first acquisition component, a second acquisition component, a comparison component and an updating component, wherein
the first acquisition component is configured to acquire a distance between the terminal and another terminal with a short-distance wireless communication function;
the second acquisition component is configured to, when the distance is shorter than or equal to a preset data transmission distance, acquire first version information of the terminal and second version information of the other terminal;
the comparison component is configured to, when a version type in the first version information of the terminal is the same as a version type in the second version information of the other terminal, compare a version level in the first version information with a version level in the second version information; and
the updating component is configured to, when the version level in the first version information is different from the version level in the second version information, perform updating according to a high-level version file.

11. The terminal as claimed in claim 10, wherein the first version information is system version information of the terminal or application program version information of the terminal;
and the second version information is system version information of the other terminal or application program version information of the other terminal.

12. The terminal as claimed in claim 10, wherein the first acquisition component comprises:
a first determination element, configured to acquire positions of the terminal and the other terminal with the short-distance wireless communication function from a server; and
a calculation element, configured to calculate the distance between the terminal and the other terminal with the short-distance wireless communication function according to the positions.

13. The terminal as claimed in claim 10, wherein the second acquisition component comprises:
a second determination element, configured to acquire the first version information of the terminal and the second version information of the other terminal from the server.

14. The terminal as claimed in claim 10, wherein the second acquisition component comprises:
a first sending element, configured to send an authentication message to the other terminal; and
a first receiving element, configured to receive the second version information, fed back by the other terminal receiving the authentication message, of the other terminal.

15. The terminal as claimed in claim 10, wherein the updating component comprises:
a second sending element, configured to, when the version level in the first version information of the terminal is lower than the version level in the second version information of the other terminal, send an updating request to the other terminal;
a second receiving element, configured to receive a version updating file fed back by the other terminal; and
a first updating element, configured to perform updating according to the version updating file.

16. The terminal as claimed in claim 15, wherein the second receiving element comprises:
a receiving sub-element, configured to enable a data sharing function and receive a version response fed back by the other terminal, wherein the version response at least comprises: the second version information of the other terminal and an acquisition manner for the version updating file of the other terminal; and
an acquisition element, configured to acquire the version updating file of the other terminal according to the version response.

17. The terminal as claimed in claim 16, wherein the acquisition element comprises:
a third sending element, configured to send a version request to the other terminal according to the version response; and
a third receiving element, configured to receive the version updating file, corresponding to the version request, of the other terminal.

18. The terminal as claimed in claim 10, wherein the updating component comprises:
a fourth receiving element, configured to, when the version level in the first version information of the terminal is higher than the version level in the second version information of the other terminal, receive an updating request from the other terminal; and
a second updating element, configured to send a version updating file to the other terminal to enable the other terminal to perform updating according to the version updating file.
